(19) United States
(12) Patent Application Publication
(10) Pub. No.: US 2012/0251421 A1
(43) Pub. Date: Oct. 4, 2012

(54) PROCESSES FOR REDUCING NITROSAMINE FORMATION DURING GAS PURIFICATION IN AMINE BASED LIQUID ABSORPTION SYSTEMS

(75) Inventor: STEPHEN A. BEDELL, KNOXVILLE, TN (US)

(73) Assignee: ALSTOM TECHNOLOGY LTD, BADEN (CH)

(21) Appl. No.: 13/354,568

(22) Filed: Jan. 20, 2012

Related U.S. Application Data
(60) Provisional application No. 61/469,233, filed on Mar. 30, 2011.

(51) Int. Cl. B01D 53/62

(52) U.S. Cl. 423/229; 423/228

(57) ABSTRACT

Acid gas purification processes for reducing nitrosamine precursor formation from a gas stream containing NOx, wherein the acid gas is selectively absorbed in an amine based wash solution comprising at least one secondary diamine. The processes generally include absorbing carbon dioxide from the gas stream containing NOx species with the amine-based wash solution comprising at least one secondary diamine to provide a carbon dioxide lean gas stream that is released into the surroundings, wherein absorbing the acid gas forms a rich amine solution; and regenerating the rich amine solution at an elevated temperature to release the carbon dioxide to form a regenerated lean amine solution, wherein absorbing and regenerating are configured to promote formation of carbamate species of at least one diamine.

### CROSS REFERENCE TO RELATED APPLICATIONS

This application claims the benefit of U.S. Provisional Application No. 61/469,233, filed Mar. 30, 2011, incorporated herein by reference in its entirety.

### BACKGROUND

The present disclosure generally relates to processes for reducing nitrosamine formation during gas purification of an acid gas stream containing NOx with amine based liquid absorption systems.

Power plants may combust various fuels, such as coal, hydrocarbons, bio-mass, waste products, and the like, in boilers, for example, to generate steam and electricity. Exhaust streams (e.g., flue gas) of such combustion processes are often treated to neutralize or remove various compounds, such as carbon dioxide (CO₂), sulfur oxides, nitrogen oxides (NOx), and particulate matter, prior to discharge of the flue gas to the environment. These downstream processes include, among others, post- combustion capture systems. The challenge here is the large volume of the flue gas due to essentially atmospheric pressure and the presence of N₂. The CO₂ contents are also relatively small which leads to very large equipment for the capture section.

In post-combustion processes used for separation of acidic gases such as CO₂ from a flue gas stream, liquid solutions comprising amine compounds or aqueous ammonia solutions are commonly used as a wash solution. The acidic gases are absorbed by the amine based wash solution in an absorption unit to form a soluble salt solution referred to as a rich amine solution containing the absorbed acid gas in an absorption process, e.g., a bicarbonate salt. The absorbed acid gas in the form of the salt is then desorbed or stripped from the amine based solvent, generally at a higher temperature and/or change in pressure, in a regeneration unit.

The ability of the amine based solvent to remove carbon dioxide is generally dependent on its equilibrium solubility as well as mass transfer and chemical kinetics characteristics. Exemplary amine compounds utilized for the amine based wash solution generally include monoethanolamine (MEA), diethanolamine (DEA), methyldiethanolamine (MDEA), diisopropanolamine (DIPA), and aminoethoxyethanol (diglycolamine), 2-amino-2-methyl-1-propanol (AMP) and various combinations thereof. The amine based wash solution may further include a promoter and/or a catalyst. The promoters and/or catalysts are generally utilized to enhance the reaction kinetics involved in the capture of CO₂. Exemplary promoters and catalysts include a secondary diamine or triamine such as piperazine or enzymes such as carbonic anhydrase or its analogs. The promoters may be in the form of a solution or immobilized on solid or semisolid surfaces. Inhibitors are generally provided to minimize corrosion and solvent degradation.

In amine based wash systems that employ secondary amines such as piperazine, nitrosamines can be formed if the acid gas stream contains NOx. The NOx, which may include NO, NO₂, N₂O₃, and solution reaction products such as NO2 interact with the secondary amines to form the nitrosamines. Nitrosamines are considered hazardous and may need special handling and/or off gas treatment.

In view of the foregoing, there is a need in the art to reduce nitrosamine formation during gas purification of gas streams that contain NOx with amine based liquid absorption systems.

### BRIEF SUMMARY

Disclosed herein are acid gas purification processes for reducing nitrosamine precursor formation from a gas stream containing NOx. In one embodiment, an acid gas purification process for reducing nitrosamine precursor formation from a gas stream containing NOx, wherein the acid gas is selectively absorbed in an amine based wash solution comprising at least one secondary diamine or triamine comprises absorbing carbon dioxide from the gas stream containing NOx species with the amine-based wash solution comprising at least one secondary diamine or triamine to provide a gas stream free of carbon dioxide that is released into the surroundings, wherein absorbing the acid gas forms a rich amine solution; and regenerating the rich amine solution at an elevated temperature to release the carbon dioxide to form a regenerated lean amine solution, wherein absorbing and regenerating are configured to promote formation of carbamate species of the at least one diamine or triamine relative to bicarbonate species.

In another embodiment, the acid gas purification process for reducing nitrosamine precursor formation from a gas stream containing NOx, wherein the acid gas is selectively absorbed in an amine based wash solution comprising at least one secondary diamine or triamine, the process comprises absorbing carbon dioxide from the gas stream containing NOx species with the amine-based wash solution comprising at least one secondary diamine or triamine to provide a carbon dioxide lean gas stream that is released into the surroundings, wherein absorbing the acid gas forms a rich amine solution; regenerating the rich amine solution at an elevated temperature to release the carbon dioxide to form a regenerated lean amine solution; and removing heat stable amine salts to less than 1%.

The disclosure may be understood more readily by reference to the following detailed description of the various features of the disclosure and the examples included therein.

### BRIEF DESCRIPTION OF THE DRAWINGS

Referring now to the figures wherein the like elements are numbered alike:

FIG. 1 depicts an exemplary liquid amine absorption system for removing acid gases from a gas stream;

FIG. 2 graphically illustrates a prior art plot of log (k₂ in M⁻¹ sec⁻¹) against the pKa for the nitrosation of various secondary amines; and

FIG. 3 graphically illustrates predicted species distribution as a function of CO₂loading in a CO₂/piperazine activated MDEA amine based solvent system.

### DETAILED DESCRIPTION

Disclosed herein are processes for reducing nitrosamine formation during gas purification of acid gas streams that include NOx with amine based liquid absorption systems that include secondary diamines or triamines. The applicant has discovered that controlling basicity during gas purification can minimize formation of nitrosamine precursors during gas purification. As will be discussed in greater detail herein, controlling basicity can generally be accomplished by minimizing formation of heat stable salts and/or controlling rich amine loading.

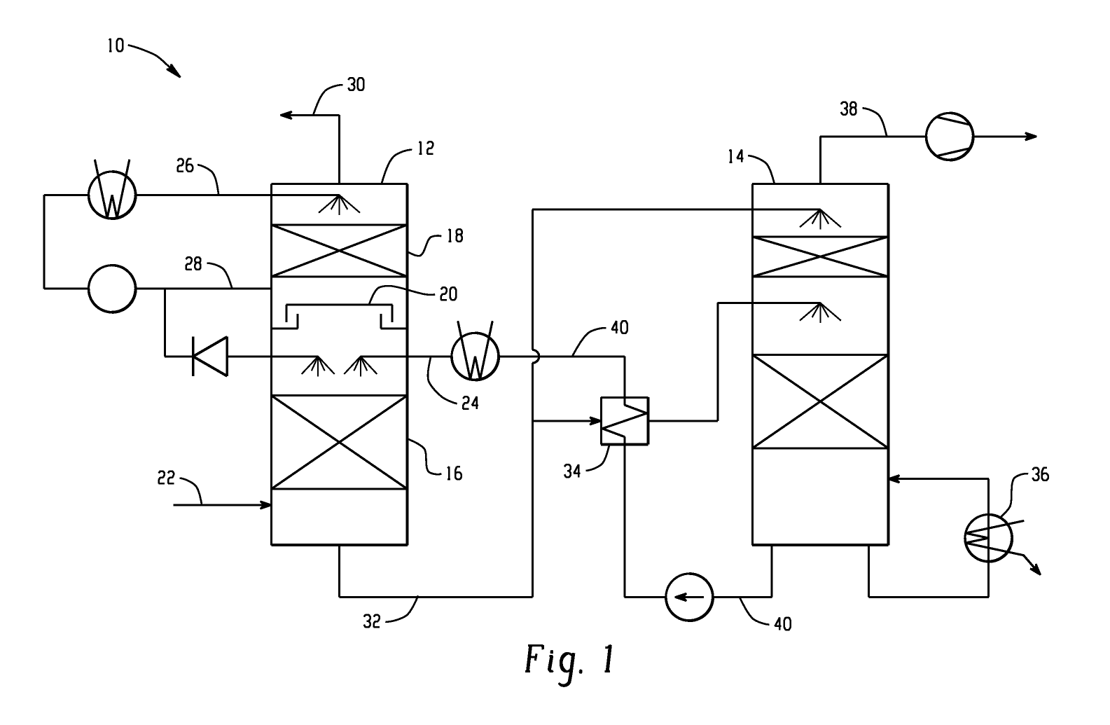

Referring now to FIG. 1, a typical gas purification system, generally designated by reference numeral 10, includes an absorption unit 12 and a regeneration unit 14. The absorption and regeneration units 12, 14 may be a column such as a packed bed column or a column containing trays. The absorption unit 12 is arranged to allow contact between a gas stream to be purified and one or more amine based wash liquids. The absorption unit generally includes an amine wash section 16 for CO₂ absorption and a water wash section 18 for contaminant removal. Intermediate to sections 16 and 18 there may be a condenser 20.

Flue gas from which CO₂ is to be removed is fed to a lower portion of the absorption unit 12 via line 22. In section 16, the flue gas is contacted in countercurrent fashion with a wash liquid comprising an amine wash liquid, e.g., by bubbling the flue gas through the wash liquid or by spraying the wash liquid into the flue gas. The amine wash liquid is fed to the absorption unit via line 24. CO₂ from the flue gas is absorbed in the amine wash liquid and is discharged from the absorption unit via line 32. The dissolved CO₂ forms carbonic acid and products of its deprotonation, which react with the amine based solvent system. In addition, promoters may form amine carbamic acid and its salts. Flue gas substantially depleted of CO₂ in the absorption section 16 then enters the water wash section 18, wherein the flue gas contacts a second wash liquid, which is generally water, for removing water soluble contaminants from the flue gas. The second wash liquid is fed to the absorption unit via line 26.

The wash water utilized in wash water section 18 is generated self sufficient by condensing part of the water vapor contained in the treated gas coming from the CO₂ absorption section 16. Excess water is not discharged as an effluent but instead is sent to the amine wash solution loop via line 28. Flue gas depleted of CO₂ and contaminants leaves the absorption unit via line 30 and may be discharged to the atmosphere. The used first and second wash liquids containing absorbed CO₂ and contaminants leave the absorption unit via line 32, which is commonly referred to as the rich amine.

The used first and second wash liquids are recycled by pumping the rich amine solution to the regenerator unit 14, wherein the acid gases such as CO₂ are then stripped from the wash liquids. A portion of the rich amine solution may be heated via heat exchanger 34 and fed to a mid-section of the regenerator (e.g., which may be at about 100 to 150° C.) or fed to the top portion of the regenerator unit 14, which can be at a markedly lower temperature so as to minimize the energy losses due to the latent heat of the water vapor (e.g., typically 40 to 60° C.). The rich amine wash solution is withdrawn from the lower section and provided to a reboiler 36 positioned downstream of the regenerator. There the CO₂ is stripped at a relatively high temperature and leaves the system via line 38.

The reboiler 36 boils the rich amine solution to form steam and a hot regenerated wash solution (i.e., lean amine solution), which is recycled for use in the absorption unit 12 via line 40. The heating of the regeneration unit from the bottom gives a temperature gradient at steady state from the bottom to the top, wherein the top portion of the regeneration unit is lower relative to the bottom depending on the configuration.

To take advantage of the thermal energy present in the lean amine solution as it exits the regeneration unit 14, the hot regenerated wash solution can be first directed to heat exchanger 34, where it exchanges heat and is cooled relative to the incoming rich amine solution from the absorption unit, which is heated. The lean amine solution is typically at a temperature of about 120° C. whereas the rich amine solution is at a temperature of about 90 to 110° C. when these solutions exit heat exchanger 34. The lean amine solution may be further cooled in a cooler, if desired, prior to use in the absorption unit 12.

The process description above is intended to represent a general description of an amine scrubber in order to illustrate the concept of the invention. It should be apparent to those skilled in the art that other process flow schemes including, but not limited to, multiple absorbers and strippers, intermediate cooling steps and alternate temperatures and pressures may be utilized.

For ease of understanding, reference will now be made to piperazine activated MDEA amine based solvent systems. Piperazine is a cyclic diamine bearing two secondary amine groups, and when used, functions as a promoter to the MDEA. Theoretically, piperazine can bind with 2 mol of CO₂. Piperazine reacts rapidly and strongly binds with CO₂ It then shuttles the CO₂ as the carbamate into the interior of the liquid. Nitrosamines can be formed when NOx from the acidic gas stream to be treated or NOx products of its reaction with water interact in solution with primary and secondary amines such as piperazine. However, the present disclosure is not intended to be limited to piperazine activated MDEA amine based solvent systems and is generally applicable to any amine based solvent system that includes a secondary diamine or triamine either as the base solvent or as the promoter. Other secondary diamines and triamines that could be used include, without limitation 1-methylpiperazine, 2-methylpiperazine, N-methylethylenediamine, diethylenetriamine, and mixtures thereof.

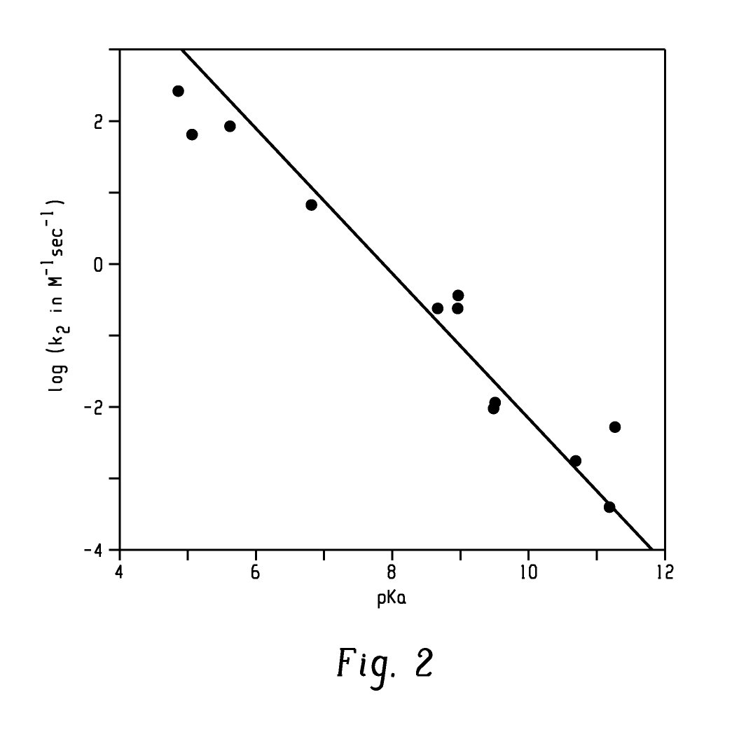

Referring now to FIG. 2, there is graphically shown a prior art plot of log (k₂ in M⁻¹ sec⁻¹) against the pKa for the nitrosation of various secondary amines. As shown, amines with low pKa (low basicity) will form nitrosamines faster than highly basic amines. This is consistent with the high reactivity of piperazine being attributed to the second less basic nitrogen. When unreacted, both amine groups are equivalent and exhibit relatively high basicity, e.g., pKa=9.7. However, when monoprotonated, the basicity of the second amine group drops to a pKa of about 5.6 and reacts many times faster with nitrosating agents to form nitrosopiperazine. For instance, from FIG. 2 it can be shown that the rate of nitrosamine formation is greater by a factor of about 10,000 for reaction of the monoprotonated piperazine. Accordingly, minimizing formation of the monoprotonated piperazine can lead to a significant reduction in nitrosamine formation, which may be accomplished by minimizing formation of heat stable salts, which increases acidity of the solvent thereby promoting piperazine protonation, and/or lowering acid gas loading, which, for similar reasons, will minimize formation of the monoprotonated piperazine species.

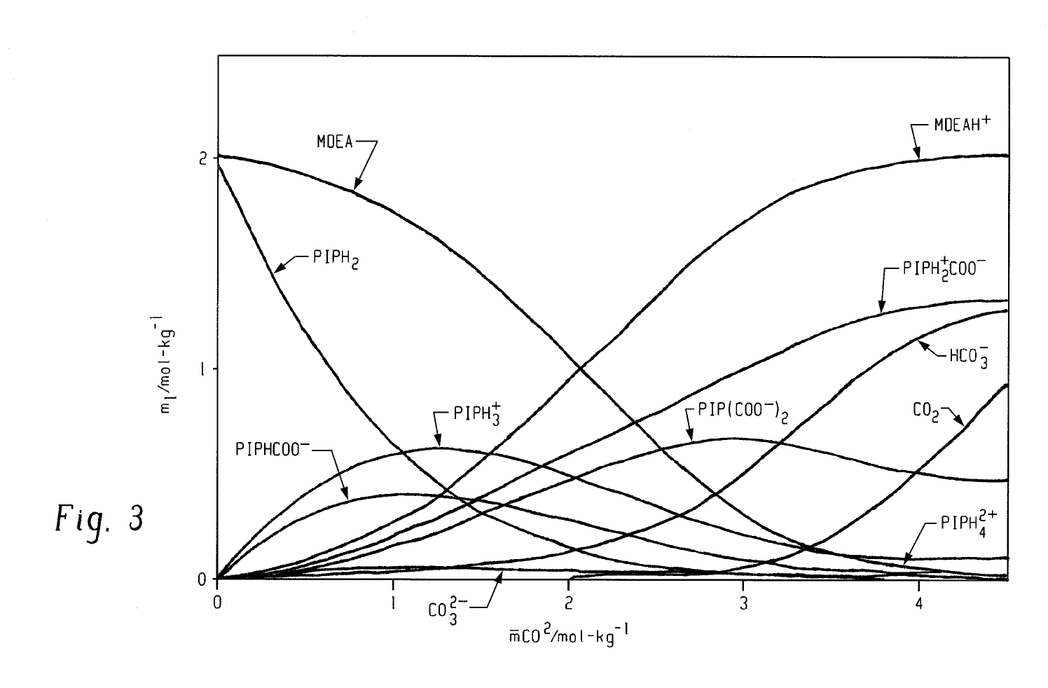

Reaction of CO₂ with piperazine generally occurs via two reaction pathways: a) formation of a bicarbonate salt, and b) formation of the piperazine carbamate (and the dicarbamate). FIG. 3 shows how variation of the split of bicarbonate/carbamate changes the concentration of nitrosamine precursor by graphically illustrating predicted species distribution as a function of CO₂ loading in a CO₂/piperazine activated MDEA system. As shown, adjustment of CO₂ loading can effectively reduce the concentration of monoprotonated piperazine, which should result in reducing the formation rate of nitrosamine. For instance, at the conditions at which FIG. 3 is based, the concentration of monoprotonated piperazine (PIPH₃⁺) reaches a maximum value at a loading of about 1.2 (mCO₂/mol-kg) At a loading of only ½ that value, the concentration of monoprotonated piperazine (and hence the reaction rate for nitrosamines) is only ½ of the maximum rate.

Accordingly, in one embodiment, the process for reducing nitrosamine formation includes decreasing the rich amine loading. For example, rich amine loading can be decreased by decreasing the amount of piperazine in the amine based wash solution and by decreasing residence time in the absorber unit. By reducing the amount of piperazine in the amine based wash solution and/or reducing residence time, the amount of absorbed CO₂ will decrease. Reduction of the CO₂ loading by a relatively small amount can have a significant effect on reducing nitrosamine formation. One skilled in the art can easily optimize nitrosamine formation with solution loading, wherein the specific ranges will vary for different solvent compositions and process conditions.

In another embodiment, the absorption unit 12 can be configured to provide a shorter pathway and/or the flow rate configured to reduce the residence time of the flue gas in the absorption unit. Doing so will maximize formation of carbamate species while minimizing bicarbonate production.

Still further, another embodiment includes minimizing formation of heat stable salts. When the amine based solvent comes into contact with the flue-gases, the amines will also react with other contaminants in the flue-gas, such as SO₂, O₂, NOx, and the like. How much of these are absorbed will vary from one amine to another, and will also depend on the design of the absorption unit. These reactions can form heat-stable salts that are non-regenerable under solvent regeneration conditions, i.e., will not be released from the amine solution by the steam stripping process in the regeneration unit. In addition, these reactions can form acids. For example, oxygen can react with the other components to form oxalic acid, acetic acid, formic acid, and the like. Since the amine mixture is circulated between the absorber and the desorber, the amount of heat-stable salts in the solvent will gradually rise. After a certain period of time, the concentration of these salts will be so high that the CO₂ absorption rate will be reduced. This is handled by the use of a reclaiming unit. Applicant has discovered that higher levels of the nitrosopiperazine precursor are formed as a function of increasing amounts of heat stable salts. In this embodiment, the system can be configured to minimize production of heat stable salts. In one embodiment, the reclaiming unit is configured to maintain the heat stable salt concentration at less than 1%. In other embodiment, the reclaiming unit is configured to maintain the heat stable salt concentration at less than 0.5%.

Advantageously, the present invention reduces formation of nitrosamine precursors.

Unless otherwise specified, all ranges disclosed herein are inclusive and combinable at the end points and all intermediate points therein. The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item. All numerals modified by “about” are inclusive of the precise numeric value unless otherwise specified.

Variations, modifications, and other implementations of what is described may be employed without departing from the spirit and scope of the invention. More specifically, any of the method, system and device features described above or incorporated by reference may be combined with any other suitable method, system or device features disclosed herein or incorporated by reference, and is within the scope of the contemplated inventions. The systems and methods may be embodied in other specific forms without departing from the spirit or essential characteristics thereof. The foregoing embodiments are therefore to be considered in all respects illustrative, rather than limiting of the invention. The teachings of all references cited herein are hereby incorporated by reference in their entirety.

What is claimed is:

1. An acid gas purification process for reducing nitrosamine precursor formation from a gas stream containing NOx, wherein the acid gas is selectively absorbed in an amine based wash solution comprising at least one secondary diamine or triamine, the process comprising:
absorbing carbon dioxide from the gas stream containing NOx species with the amine-based wash solution comprising at least one secondary diamine or triamine to provide a carbon dioxide lean gas stream that is released into the surroundings, wherein absorbing the acid gas forms a rich amine solution; and
regenerating the rich amine solution at an elevated temperature to release the carbon dioxide to form a regenerated lean amine solution, wherein absorbing and regenerating are configured to promote formation of carbamate species of the at least one diamine or triamine relative to the formation of a bicarbonate species.

2. The process of claim 1, wherein the amine based wash solution is a piperazine activated methyldiethanolamine solution.

3. The process of claim 1, wherein formation of the carbamate species comprises reducing residence time in the absorption unit.

4. The process of claim 1, wherein formation of the carbamate species comprises increasing solution basicity to prevent protonation of secondary amine.

5. The process of claim 1, wherein at least one secondary diamine or triamine is piperazine.

6. The process of claim 1, wherein formation of the carbamate species comprises reducing the CO₂ loading in the rich amine solution.

7. The process of claim 1, wherein the amine comprises 1-methylpiperazine, 2-methylpiperazine, N-methylethylenediamine, diethylenetriamine, and mixtures thereof.

8. The acid gas purification process of claim 1, wherein the amine based wash solution comprises monoethanolamine (MEA), diethanolamine (DEA), methyldiethanolamine (MDEA), diisopropanolamine (DIPA), and aminoethoxyethanol (diglycolamine), 2-amino-2-methyl-1-propanol (AMP) and various combinations thereof in addition to the secondary diamine or triamine.

9. An acid gas purification process for reducing nitrosamine precursor formation from a gas stream containing NOx, wherein the acid gas is selectively absorbed in an amine based wash solution comprising at least one secondary diamine or triamine, the process comprising:
absorbing carbon dioxide from the gas stream containing NOx species with the amine-based wash solution comprising at least one secondary diamine or triamine to provide a carbon dioxide lean gas stream that is released into the surroundings, wherein absorbing the acid gas forms a rich amine solution;
regenerating the rich amine solution at an elevated temperature to release the carbon dioxide to form a regenerated lean amine solution; and
removing heat stable amine salts to less than 1%.

10. The acid gas purification process of claim 9, wherein removing the heat stable amine salts is to less than 0.5%.
